(19) United States
(12) Patent Application Publication
(10) Pub. No.: US 2024/0397429 A1
(43) Pub. Date: Nov. 28, 2024

(54) DRX EXTENSION FOR ENERGY HARVESTING REDCAP UES

(71) Applicant: Nokia Technologies Oy, Espoo (FI)

(72) Inventors: Muhammad Majid BUTT, Naperville, IL (US); Ahlem KHLASS, Massy (FR); Rapeepat RATASUK, Naperville, IL (US); Nitin MANGALVEDHE, Naperville, IL (US); Muhammad TAYYAB, Oulu (FI)

(21) Appl. No.: 18/689,682

(22) PCT Filed: Dec. 8, 2022
(86) PCT No.: PCT/IB2022/061943

§ 371 Date: Mar. 6, 2024

Related U.S. Application Data
(60) Provisional application No. 63/290,925, filed on Dec. 17, 2021.

(51) Int. Cl. H04W 52/02; H02N 11/00; H04W 76/28

(52) U.S. Cl. CPC H04W 52/0251; H04W 76/28; H02N 11/002

(57) ABSTRACT

In a system, apparatus, method, and non-transitory computer readable medium for implementing DRX extensions for energy harvesting (EH) REDCAP UEs, a UE device may be caused to, obtain CDRX configuration from a RAN node, the CDRX configuration including at least a desired EH CDRX energy threshold value and a short CDRX timer threshold value, determine whether a current stored energy capacity equals or exceeds the desired EH CDRX energy threshold value at a start of an ON duration of a CDRX cycle, determine EH CDRX settings based on results of the determining and the plurality of adaptive EH CDRX configuration settings, and transmit at least one EH CDRX message to the RAN node based on the determined EH CDRX settings.

### BACKGROUND

### Field

Various example embodiments relate to methods, apparatuses, systems, and/or non-transitory computer readable media for providing DRX extensions for energy harvesting (EH) reduced capability (REDCAP) user equipment (UE) devices.

### DESCRIPTION OF THE RELATED ART

A 5^{th} generation mobile network (5G) standard, referred to as 5G New Radio (NR), is being developed to provide higher capacity, higher reliability, and lower latency communications than the 4G long term evolution (LTE) standard.

The 5G NR standard provides user equipment (UE) devices (hereinafter referred to as UE devices or UEs) a discontinuous reception (DRX) mode for UE devices which allows the UE devices to enter a power saving mode (and/or a sleep mode) for a desired period of time of a DRX cycle (e.g., an OFF period/duration, etc.), and to wake up from the power saving mode to check for data coming from the network during a desired period of time of the DRX cycle (e.g., an ON period/duration, etc.). This DRX cycle allows the UE device to save power by turning off (and/or substantially turning off) all radio equipment during the OFF period of the DRX cycle, and then turn the radio equipment on to monitor the physical downlink control channel (PDCCH) to determine if there is downlink data from the network during the ON period of the DRX cycle. Relevantly, the 5G standard further defines a connected mode DRX (CDRX) mode for UEs in radio resource control (RRC) Connected state which includes a “long DRX cycle” and a “short DRX cycle,” wherein the long DRX cycle duration is defined to be several multiples longer than the defined short DRX cycle duration, and the network (e.g., a radio access network (RAN) node, core network, and/or network operator, etc.) and the UE device may operate using either the short DRX cycle or the long DRX cycle, or several short DRX cycles followed by a long DRX cycle, etc.

Additionally, the 5G standard further introduces the concept of reduced capability (REDCAP) UE devices operating on the 5G network. REDCAP UE devices are UE devices which may have reduced processing, memory, and/or energy capabilities in comparison to standard UE devices, and REDCAP UE devices may include industrial wireless sensors, video surveillance devices, and/or wearable smart devices, etc. Due to the physical limitations of REDCAP UE devices, particularly in terms of energy storage capabilities, there is a noted desire to further supplement the energy storage capabilities of UE devices, and REDCAP UE devices in particular, with the use of and/or connection to energy harvesting (EH) devices, such as solar panels, windmills, heat capture devices, radio frequency (RF) energy harvesting devices, kinetic energy harvesting devices, etc., which provide additional energy (e.g., recharge) to any batteries included in the UE device and/or REDCAP UE device. However, the current DRX implementation provides a tradeoff between the UE device's increased power efficiency due to the UE device's ability to enter a power saving mode periodically, but at the expense of reduced UE reachability, availability, and/or increased data reception latency, etc.

### SUMMARY

At least one example embodiment relates to a user equipment (UE) device.

In at least one example embodiment, the UE device may include a memory storing computer readable instructions and processing circuitry configured to execute the computer readable instructions to cause the device to, obtain connected mode discontinuous reception (CDRX) configuration from a Radio Access Network (RAN) node, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value, determine whether a current stored energy capacity equals or exceeds the desired EH CDRX energy threshold value at a start of an ON duration of a CDRX cycle, determine EH CDRX settings based on results of the determining whether the current stored energy capacity equals or exceeds the desired EH CDRX energy threshold value and the plurality of adaptive EH CDRX configuration settings, and transmit at least one EH CDRX message to the RAN node based on the determined EH CDRX settings.

Some example embodiments provide that the plurality of adaptive EH CDRX configuration settings further includes a short CDRX cycle extension threshold value, and the device is further caused to initialize a value of a short CDRX cycle extension variable, and in response to the current stored energy capacity equaling or exceeding the desired EH CDRX energy threshold value, increment the value of the short CDRX cycle extension variable, determine whether the value of a short CDRX cycle extension variable equals the short CDRX cycle extension threshold value, and transmit a first EH CDRX message to the RAN node, the first EH CDRX message indicating a start of a EH short CDRX cycle.

Some example embodiments provide that the device is further caused to determine the EH CDRX settings by, in response to the value of the short CDRX cycle extension variable equaling the short CDRX cycle extension threshold value, or in response to the current stored energy capacity being less than the desired EH CDRX energy threshold value, resetting the value of the short CDRX cycle extension variable, incrementing a value of a short CDRX timer variable, determining whether the incremented value of the short CDRX timer variable equals the short CDRX timer threshold value, and starting a long CDRX cycle based on the results of the determining whether the incremented value of the short CDRX timer variable equals the short CDRX timer threshold value.

Some example embodiments provide that the plurality of adaptive EH CDRX configuration settings further includes an early short CDRX cycle termination threshold value, and the device is further caused to determine the EH CDRX settings by, in response to the current stored energy capacity equaling or exceeding the desired EH CDRX energy threshold value, resetting an early short CDRX cycle termination variable.

Some example embodiments provide that the device is further caused to determine the EH CDRX settings by, in response to the current stored energy capacity being less than the desired EH CDRX energy threshold value, incrementing the value of the early short CDRX cycle termination variable, determining whether the incremented value of the early short CDRX cycle termination variable equals the early short CDRX cycle termination threshold value, and transmitting a second EH CDRX message to the RAN node based on results of the determining whether the incremented value of the early short CDRX cycle termination variable equals the early short CDRX cycle termination threshold value, the second EH CDRX message indicating a stop to the short CDRX cycle timer.

Some example embodiments provide that a value of the early short CDRX cycle termination threshold value is less than the value of the short CDRX timer threshold value.

Some example embodiments provide that the plurality of adaptive EH CDRX configuration settings further includes an early long CDRX cycle termination threshold value, and the device is further caused to, determine the EH CDRX settings by determining whether the current stored energy capacity equals or exceeds a sum of the desired EH CDRX energy threshold value and the early long CDRX cycle termination threshold value at a start of an ON duration of a long CDRX cycle, and transmit a third EH CDRX message to the RAN node, the third EH CDRX message indicating an end of the long CDRX cycle.

Some example embodiments provide that the device is further caused to, transmit at least one of the first EH CDRX message, a second EH CDRX message, a third EH CDRX message, or any combinations thereof, as an Uplink Control Information (UCI) message, the UCI message including a 1-bit flag indicating the determined EH CDRX settings.

Some example embodiments provide that the device further comprises, at least one energy harvesting device, and at least one battery configured to store energy obtained by the at least one energy harvesting device.

At least one example embodiment relates to method of operating a user equipment (UE) device.

In at least one example embodiment, the method may include obtaining connected mode discontinuous reception (CDRX) configuration from a Radio Access Network (RAN) node, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value, determining whether a current stored energy capacity equals or exceeds the desired EH CDRX energy threshold value at a start of an ON duration of a CDRX cycle, determining EH CDRX settings based on results of the determining whether the current stored energy capacity equals or exceeds the desired EH CDRX energy threshold value and the plurality of adaptive CDRX configuration settings, and transmitting at least one EH CDRX message to the RAN node based on the determined EH CDRX settings.

Some example embodiments provide that the plurality of adaptive EH CDRX configuration settings further includes a short CDRX cycle extension threshold value, the determining the EH CDRX settings further includes, initializing a value of a short CDRX cycle extension variable, and in response to the current stored energy capacity equaling or exceeding the desired EH CDRX energy threshold value, the method further includes, incrementing the value of the short DRX cycle extension variable, determining whether a value of a short CDRX cycle extension variable equals the short CDRX cycle extension threshold value, and transmitting a first EH CDRX message, the first EH CDRX message indicating a start of an EH short CDRX cycle.

Some example embodiments provide that the determining the EH CDRX settings further comprises, in response to the value of the short CDRX cycle extension variable equaling the short CDRX cycle extension threshold value, or in response to the current stored energy capacity being less than the desired EH CDRX energy threshold value, resetting the value of the short CDRX cycle extension variable, incrementing a value of a short CDRX timer variable, determining whether the incremented value of the short CDRX timer variable equals the short CDRX timer threshold value; and starting a long CDRX cycle based on the results of the determining whether the incremented value of the short CDRX timer variable equals the short CDRX timer threshold value.

Some example embodiments provide that the plurality of adaptive EH CDRX configuration settings further includes an early short CDRX cycle termination threshold value, and the determining the EH CDRX settings further comprises, in response to the current stored energy capacity equaling or exceeding the desired EH CDRX energy threshold value, resetting an early short CDRX cycle termination variable.

Some example embodiments provide that the determining the EH CDRX settings further comprises, in response to the current stored energy capacity being less than the desired EH CDRX energy threshold value, incrementing the value of the early short CDRX cycle termination variable, determining whether the incremented value of the early short CDRX cycle termination variable equals the early short CDRX cycle termination threshold value, and transmitting a second EH CDRX message to the RAN node based on results of the determining whether the incremented value of the short CDRX cycle termination variable equals the early short CDRX cycle termination threshold value, the second EH CDRX message indicating a stop to the short CDRX cycle timer.

Some example embodiments provide that a value of the early short CDRX cycle termination threshold value is less than the value of the short CDRX timer threshold value.

At least one example embodiment relates to a radio access network (RAN) node.

In at least one example embodiment, the node may include a memory storing computer readable instructions and processing circuitry configured to execute the computer readable instructions to cause the node to, transmit connected mode discontinuous reception (CDRX) configuration to at least one energy harvesting (EH) user equipment (UE) device, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value, and receive at least one EH CDRX message from the at least one EH UE device, the at least one EH CDRX message indicating EH CDRX settings determined based on at least a current stored energy capacity of the at least one EH UE device, the desired CDRX energy threshold value and the plurality of adaptive CDRX configuration settings.

Some example embodiments provide that the node is further caused to, transmit the CDRX configuration to a plurality of EH UE devices connected to the node.

At least one example embodiment relates to a user equipment (UE) device.

In at least one example embodiment, the UE device may include means for, obtaining connected mode discontinuous reception (CDRX) configuration from a Radio Access Network (RAN) node, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value, determining whether a current stored energy capacity equals or exceeds the desired EH CDRX energy threshold value at a start of an ON duration of a CDRX cycle, determining EH CDRX settings based on results of the determining whether the current stored energy capacity equals or exceeds the desired EH CDRX energy threshold value and the plurality of adaptive EH CDRX configuration settings, and transmitting at least one EH CDRX message to the RAN node based on the determined EH CDRX settings.

Some example embodiments provide that the plurality of adaptive EH CDRX configuration settings further includes a short CDRX cycle extension threshold value, and the device further includes means for, initializing a value of a short CDRX cycle extension variable, and in response to the current stored energy capacity equaling or exceeding the desired EH CDRX energy threshold value, incrementing the value of the short CDRX cycle extension variable, determining whether the value of a short CDRX cycle extension variable equals the short CDRX cycle extension threshold value, and transmitting a first EH CDRX message to the RAN node, the first EH CDRX message indicating a start of a EH short CDRX cycle.

Some example embodiments provide that the device further includes means for determining the EH CDRX settings by, in response to the value of the short CDRX cycle extension variable equaling the short CDRX cycle extension threshold value, or in response to the current stored energy capacity being less than the desired EH CDRX energy threshold value, resetting the value of the short CDRX cycle extension variable, incrementing a value of a short CDRX timer variable, determining whether the incremented value of the short CDRX timer variable equals the short CDRX timer threshold value, and starting a long CDRX cycle based on the results of the determining whether the incremented value of the short CDRX timer variable equals the short CDRX timer threshold value.

Some example embodiments provide that the plurality of adaptive EH CDRX configuration settings further includes an early short CDRX cycle termination threshold value, and the device further includes means for determining the EH CDRX settings by, in response to the current stored energy capacity equaling or exceeding the desired EH CDRX energy threshold value, resetting an early short CDRX cycle termination variable.

Some example embodiments provide that the device further includes means for determining the EH CDRX settings by, in response to the current stored energy capacity being less than the desired EH CDRX energy threshold value, incrementing the value of the early short CDRX cycle termination variable, determining whether the incremented value of the early short CDRX cycle termination variable equals the early short CDRX cycle termination threshold value, and transmitting a second EH CDRX message to the RAN node based on results of the determining whether the incremented value of the early short CDRX cycle termination variable equals the early short CDRX cycle termination threshold value, the second EH CDRX message indicating a stop to the short CDRX cycle timer.

Some example embodiments provide that a value of the early short CDRX cycle termination threshold value is less than the value of the short CDRX timer threshold value.

Some example embodiments provide that the plurality of adaptive EH CDRX configuration settings further includes an early long CDRX cycle termination threshold value, and the device further includes means for, determining the EH CDRX settings by determining whether the current stored energy capacity equals or exceeds a sum of the desired EH CDRX energy threshold value and the early long CDRX cycle termination threshold value at a start of an ON duration of a long CDRX cycle, and transmitting a third EH CDRX message to the RAN node, the third EH CDRX message indicating an end of the long CDRX cycle.

Some example embodiments provide that the device further includes means for, transmitting at least one of the first EH CDRX message, a second EH CDRX message, a third EH CDRX message, or any combinations thereof, as an Uplink Control Information (UCI) message, the UCI message including a 1-bit flag indicating the determined EH CDRX settings.

Some example embodiments provide that the device further includes means for, storing energy obtained by at least one energy harvesting device.

At least one example embodiment relates to a radio access network (RAN) node.

In at least one example embodiment, the node may include means for, transmitting connected mode discontinuous reception (CDRX) configuration to at least one energy harvesting (EH) user equipment (UE) device, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value, and receiving at least one EH CDRX message from the at least one EH UE device, the at least one EH CDRX message indicating EH CDRX settings determined based on at least a current stored energy capacity of the at least one EH UE device, the desired CDRX energy threshold value and the plurality of adaptive CDRX configuration settings.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a wireless communication system according to at least one example embodiment;

FIG. 2 illustrates a block diagram of an example RAN node according to at least one example embodiment;

FIG. 3 illustrates a block diagram of an example UE device according to at least one example embodiment;

FIG. 4 illustrates an example connected mode DRX (CDRX mode) cycle according to at least one example embodiment; and

FIG. 5A illustrates an example transmission flow diagram between at least one EH UE device and at least one RAN node according to at least one example embodiment;

FIG. 5B an example flowchart of the EH-CDRX cycles according to at least one example embodiment; and

FIG. 6 is a state diagram corresponding to the at least one example embodiment of FIG. 5B.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

While the various example embodiments of the present disclosure are discussed in connection with the 5G wireless communication standard for the sake of clarity and convenience, the example embodiments are not limited thereto, and one of ordinary skill in the art would recognize the example embodiments may be applicable to other wireless communication standards, such as the 4G standard, a Wi-Fi standard, a future 6G standard, a future 7G standard, etc.

Various example embodiments are directed towards extensions and/or enhancements to connected mode DRX (CDRX mode) to accommodate energy harvesting (EH) UE devices and/or EH REDCAP UE devices. The various example embodiments improve the power savings and/or power efficiency of EH UE devices operating in CDRX mode, especially EH REDCAP UE devices, by providing the EH UE devices with the ability to adaptively and/or dynamically modify the length of short DRX cycles and/or long DRX cycles (e.g., short CDRX cycles and/or long CDRX cycles) based on the current battery level (e.g., current battery state, current battery status, etc.) of the EH UE device, including any energy harvested by the EH UE device, etc. According to at least one example embodiment, the EH UE device may adaptively and/or dynamically extend short CDRX cycles, adaptively and/or dynamically terminate short CDRX cycles early (e.g., before the expected termination of the short CDRX cycle, etc.), and/or adaptively and/or dynamically terminate long CDRX cycles early, based on the current battery level, thereby improving and/or optimizing the energy efficiency and sustainability of the EH UE devices, while also improving and/or optimizing the latency and/or reliability of communications with the UE device operating in CDRX mode, but the example embodiments are not limited thereto.

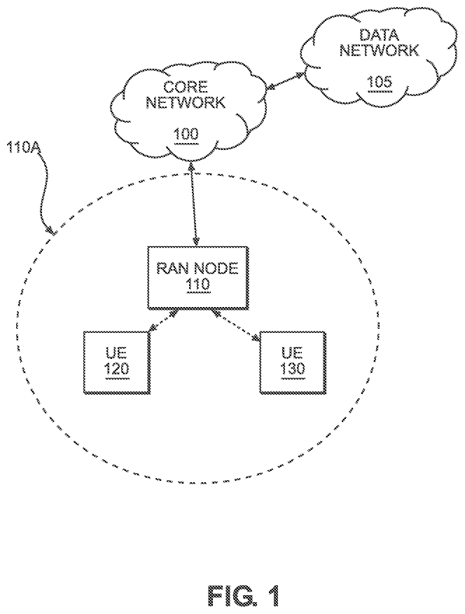

FIG. 1 illustrates a wireless communication system according to at least one example embodiment. As shown in FIG. 1, a wireless communication system includes a core network 100, and a Data Network 105, a first radio access network (RAN) node 110, a first user equipment device (e.g., UE device or UE, etc.) 120, and/or a second UE device 130, etc., but the example embodiments are not limited thereto and the example embodiments may include a greater or lesser number of constituent elements. For example, the wireless communication system may include two or more RAN nodes, one UE device, three or more UE devices, additional base stations, servers, routers, access points, gateways, etc.

The RAN node 110, the UE device 120 and/or the UE device 130 may be connected over a wireless network, such as a cellular wireless access network (e.g., a 3G wireless access network, a 4G-Long Term Evolution (LTE) network, a 5G-New Radio (e.g., 5G) wireless network, a 6G wireless network, a WiFi network, etc.). The wireless network may include a core network 100 and/or a Data Network 105. The RAN node 110 may connect to other RAN nodes (not shown), as well as to the core network 100 and/or the Data Network 105, over a wired and/or wireless network. The core network 100 and the Data Network 105 may connect to each other over a wired and/or wireless network. The Data Network 105 may refer to the Internet, an intranet, a wide area network, etc.

According to some example embodiments, the RAN node 110 may act as a relay node (e.g., an integrated access and backhaul (IAB) node) and may communicate with the UE devices 120 and/or 130, etc., in combination with at least one base station (and/or access point (AP), router, etc.) (not shown) of the same or a different radio access technology (e.g., WiFi, etc.).

The UE devices 120, 130, etc., may be any one of, but not limited to, a mobile device, a smartphone, a tablet, a laptop computer, a wearable device, an Internet of Things (IoT) device, a sensor (e.g., thermometers, humidity sensors, pressure sensors, motion sensors, accelerometers, etc.), actuators, robotic devices, robotics, drones, connected medical devices, eHealth devices, smart city related devices, a security camera, autonomous devices (e.g., autonomous cars, etc.), a desktop computer and/or any other type of stationary or portable device capable of operating according to, for example, the 5G NR communication standard, and/or other wireless communication standard(s). The UE devices 120, 130, etc., may be configurable to transmit and/or receive data in accordance to strict latency, reliability, and/or accuracy requirements, such as DRX communications, URLLC communications, TSC communications, etc., but the example embodiments are not limited thereto.

According to at least one example embodiment, the UE devices 120, 130, etc., may be energy harvesting UE devices (and/or EH REDCAP UE devices, etc.) and may be configured to harvest energy using EH devices, apparatuses, and/or means, such as solar cells/panels, wind turbines, water turbines, heat pumps, geothermal heat pumps, kinetic energy harvesting devices and/or vibration harvesting devices, radio frequency harvesting devices, etc., but the example embodiments are not limited thereto. According to at least one example embodiment, the EH UE device 120, 130, etc., may harvest (e.g., obtain, etc.) energy from the at least one EH harvesting device included in, connected to, and/or attached to the UE device, and the EH UE device 120, 130, etc., may store the harvested energy in at least one energy storage device (e.g., a battery, etc.) included in, connected to, and/or associated with the UE device, etc., but the example embodiments are not limited thereto.

Further, the EH UE device 120, 130, etc., may be configured to perform CDRX operation (e.g., DRX operation, etc.) during a short CDRX cycle or a long CDRX cycle, and each of the CDRX cycles may include at least one ON period (e.g., ON duration, etc.) during which the one or more UE devices may perform data transmission and/or data reception, and at least one OFF period (e.g., OFF duration, etc.) during which the one or more UE devices 120, 130, etc., are in a sleep mode, e.g., the UE devices have their wireless radio units powered off and/or do not perform data reception, etc. Additionally, the EH UE devices 120, 130, etc., may transmit messages to the core network, e.g., at least one radio access network (RAN) of the core network, indicating that the EH UE device desires and/or intends to continue to operate using short CDRX cycles, e.g., extend the duration of the short CDRX cycle for a desired number of cycles, etc., based on the current battery level of the EH UE device, etc. According to at least one example embodiment, the core network 100 and/or RAN node 110 may transmit initial CDRX configuration settings (e.g., default CDRX configuration settings, network CDRX configuration settings, etc.) to the EH UE device(s) 120, 130, etc., such as the length and/or duration of the initial short CDRX cycle (e.g., the length and/or duration of the initial ON period of the short CDRX cycle, and/or the length and/or duration of the initial OFF period of the short CDRX cycle, etc.), the length and/or duration of the initial long CDRX cycle (e.g., the length and/or duration of the initial ON period of the short CDRX cycle, and/or the length and/or duration of the initial OFF period of the short CDRX cycle, etc.), etc., but the example embodiments are not limited thereto. The EH UE devices 120, 130, etc., may be configured to and/or caused to perform CDRX operation based on the initial CDRX configuration settings, etc.

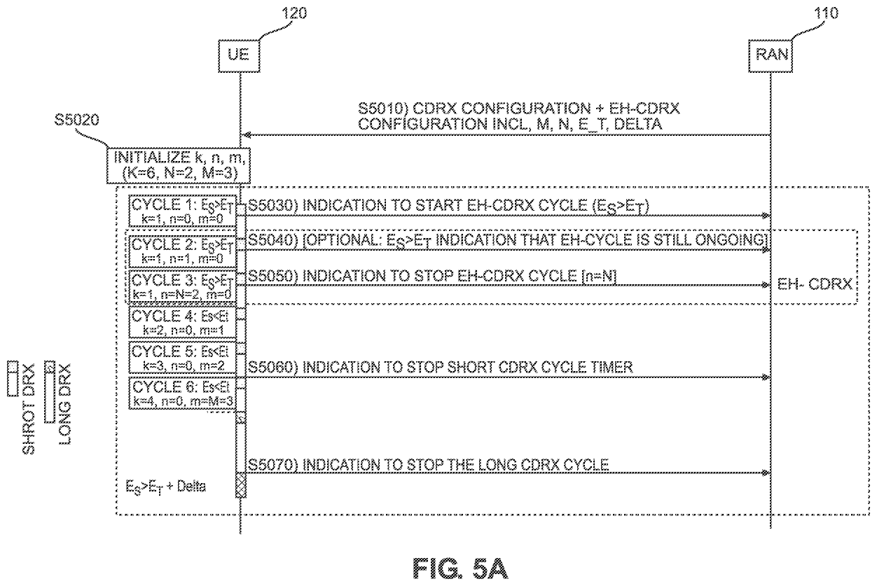

According to some example embodiments, the initial CDRX configuration settings may further include EH-CDRX configuration settings, such as a desired EH CDRX energy threshold value, a short CDRX timer threshold value, a short CDRX cycle extension threshold value, an early short CDRX cycle termination threshold value, and/or an early long CDRX cycle termination threshold value, etc., but the example embodiments are not limited thereto. The EH-CDRX configuration settings will be discussed in greater detail in connection with FIGS. 5A to 5B.

The wireless communication system further includes at least one RAN node (e.g., a base station, a wireless access point, etc.), such as RAN node 110, etc. The RAN node 110, etc., may operate according to an underlying cellular and/or wireless radio access technology (RAT), such as 5G NR, LTE, Wi-Fi, etc. For example, the RAN node 110 may be a 5G gNB node, a LTE eNB node, or a LTE ng-eNB node, etc., but the example embodiments are not limited thereto. The RAN node 110 may provide wireless network services to one or more UE devices within one or more cells (e.g., cell service areas, broadcast areas, serving areas, coverage areas, etc.) surrounding the respective physical location of the RAN node, such as a cell 110A surrounding the RAN node 110, etc.

For example, UE devices 120, 130, etc., are located within the cell service area 110A, and may connect to, receive broadcast messages from, receive paging messages from, receive/transmit signaling messages from/to, and/or access the wireless network through, etc., RAN node 110 (e.g., the source RAN node serving the UE device, etc.), but the example embodiments are not limited thereto.

While FIG. 1 illustrates a single cell for the RAN node 110, the example embodiments are not limited thereto, and for example, the RAN node may provide a plurality of cells, etc.

Additionally, the RAN node 110 may be configured to operate in a multi-user (MU) multiple input multiple out (MIMO) mode and/or a massive MIMO (mMIMO) mode, wherein the RAN node 110 transmits a plurality of beams (e.g., radio channels, datastreams, streams, etc.) in different spatial domains and/or frequency domains using a plurality of antennas (e.g., antenna panels, antenna elements, an antenna array, etc.) and beamforming and/or beamsteering techniques.

The RAN node 110 may be connected to at least one core network element (not shown) residing on the core network 100, such as a core network device, a core network server, access points, switches, routers, nodes, etc., but the example embodiments are not limited thereto. The core network 100 may provide network functions, such as an access and mobility management function (AMF), a session management function (SMF), a policy control function (PCF), a unified data management (UDM), a user plane function (UPF), an authentication server function (AUSF), an application function (AF), and/or a network slice selection function (NSSF), etc., and/or equivalent functions, but the example embodiments are not limited thereto.

While certain components of a wireless communication network are shown as part of the wireless communication system of FIG. 1, the example embodiments are not limited thereto, and the wireless communication network may include components other than that shown in FIG. 1, which are desired, necessary, and/or beneficial for operation of the underlying networks within the wireless communication system, such as access points, switches, routers, nodes, servers, gateways, etc.

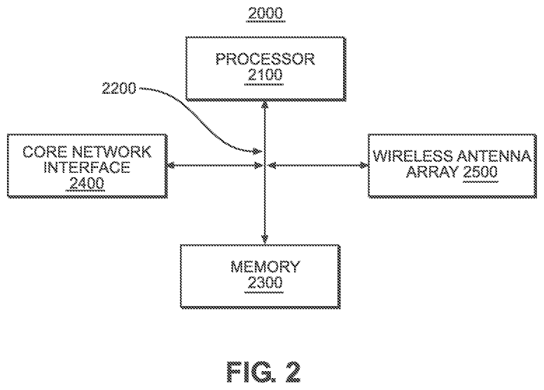

FIG. 2 illustrates a block diagram of an example RAN node according to at least one example embodiment. The RAN node of FIG. 2 may correspond to the RAN node 110 of FIG. 1, but the example embodiments are not limited thereto.

Referring to FIG. 2, a RAN node 2000 may include processing circuitry, such as at least one processor 2100, at least one communication bus 2200, a memory 2300, at least one core network interface 2400, and/or at least one wireless antenna array 2500, etc., but the example embodiments are not limited thereto. For example, the core network interface 2400 and the wireless antenna array 2500 may be combined into a single network interface, etc., or the RAN node 2000 may include a plurality of wireless antenna arrays, a plurality of core network interfaces, etc., and/or any combinations thereof. The memory 2300 may include various special purpose program code including computer executable instructions which may cause the RAN node 2000 to perform the one or more of the methods of the example embodiments.

In at least one example embodiment, the processing circuitry may include at least one processor (and/or processor cores, distributed processors, networked processors, etc.), such as the at least one processor 2100, which may be configured to control one or more elements of the RAN node 2000, and thereby cause the RAN node 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire RAN node 2000. Once the special purpose program instructions are loaded into, (e.g., the at least one processor 2100, etc.), the at least one processor 2100 executes the special purpose program instructions, thereby transforming the at least one processor 2100 into a special purpose processor.

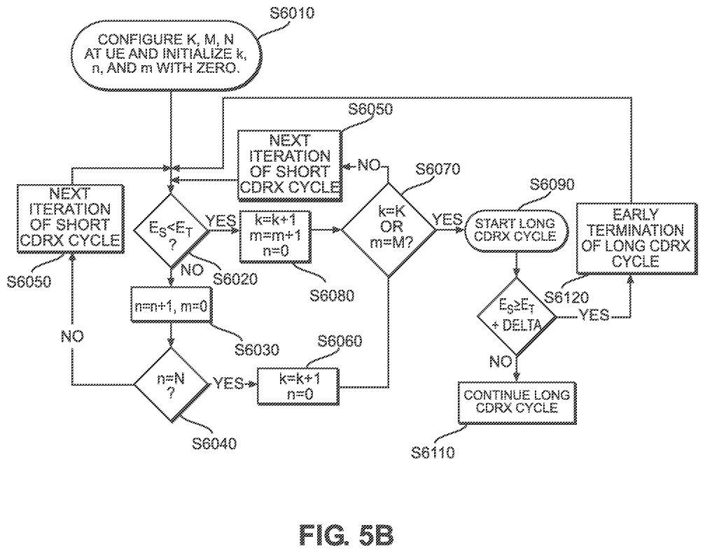

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the RAN node 2000, such as the methods discussed in connection with FIGS. 5 to 7, the at least one core network interface 2400, and/or at least one wireless antenna array 2500, etc. Such software elements may be loaded from a non-transitory computer-readable storage medium independent of the memory 2300, using a drive mechanism (not shown) connected to the RAN node 2000, or via the at least one core network interface 2400, and/or at least one wireless antenna array 2500, etc.

In at least one example embodiment, the communication bus 2200 may enable communication and data transmission to be performed between elements of the RAN node 2000. The bus 2200 may be implemented using a high-speed serial bus, a parallel bus, and/or any other appropriate communication technology. According to at least one example embodiment, the RAN node 2000 may include a plurality of communication buses (not shown), such as an address bus, a data bus, etc.

The RAN node 2000 may operate as, for example, a 4G RAN node, a 5G RAN node, etc., and may be configured to schedule time domain resource allocations (TDRAs), e.g., orthogonal frequency division multiplexing (OFDM) symbols, physical resource blocks (PRBs), resource elements, etc., for UE devices connected to the RAN node 2000, but the example embodiments are not limited thereto.

For example, the RAN node 2000 may allocate time-frequency resources of a carrier (e.g., resource blocks with time and frequency dimensions) based on operation on the time domain (e.g., time division duplexing) and/or the frequency domain (e.g., frequency division duplexing). In the time domain context, the RAN node 2000 will allocate a carrier (or subbands of the carrier) to one or more UEs (e.g., UE 120, etc.) connected to the RAN node 2000 during designated upload (e.g., uplink (UL)) time periods and designated download (e.g., downlink (DL)) time periods, or during designated special(S) time periods which may be used for UL and/or DL, but the example embodiments are not limited thereto.

When there are multiple UEs connected to the RAN node 2000, the carrier is shared in time such that each UE is scheduled by the RAN node 2000, and the RAN node 2000 allocates each UE with their own uplink time and/or downlink time. In the frequency domain context and/or when performing spatial domain multiplexing of UEs (e.g., MU MIMO, etc.), the RAN node 2000 will allocate separate frequency subbands of the carrier to UEs simultaneously served by the RAN node 2000, for uplink and/or downlink transmissions. Data transmission between the UE and the RAN node 2000 may occur on a radio frame basis in both the time domain and frequency domain contexts. The minimum resource unit for allocation and/or assignment by the RAN node 2000 to a particular UE device corresponds to a specific downlink/uplink time interval (e.g., one OFDM symbol, one slot, one minislot, one subframe, etc.) and/or a specific downlink/uplink resource block (e.g., twelve adjacent subcarriers, a frequency subband, etc.).

For the sake of clarity and consistency, the example embodiments will be described as using the time domain, but the example embodiments are not limited thereto.

Additionally, the RAN node 2000 may transmit scheduling information via physical downlink common channel (PDCCH) information to the one or more UE devices located within the cell servicing area of the RAN node 2000, which may configure the one or more UE devices to transmit (e.g., UL transmissions via physical uplink control channel (PUCCH) information and/or physical uplink shared channel information (PUSCH), etc.) and/or receive (e.g., DL transmissions via PDCCH and/or physical downlink shared channel information (PDSCH), etc.) data packets to and/or from the RAN node 2000. For example, the UE devices 120 and/or 130, etc., may monitor the PDCCH during the ON period of each CDRX cycle to determine if there is any data on the network to download, etc., but the example embodiments are not limited thereto. Additionally, the RAN node 2000 may transmit control messages to the UE device using downlink control information (DCI) messages via physical (PHY) layer signaling, medium access control (MAC) layer control element (CE) signaling, radio resource control (RRC) signaling, etc., but the example embodiments are not limited thereto.

The RAN node 2000 may also include at least one core network interface 2400, and/or at least one wireless antenna array 2500, etc. The at least one wireless antenna array 2500 may include an associated array of radio units (not shown) and may be used to transmit the wireless signals in accordance with a radio access technology, such as 4G LTE wireless signals, 5G NR wireless signals, etc., to at least one UE device, such as UE 120, etc. According to some example embodiments, the wireless antenna array 2500 may be a single antenna, or may be a plurality of antennas, etc. For example, the wireless antenna array 2500 may be configured as a grid of beams (GoB) which transmits a plurality of beams in different directions, angles, frequencies, and/or with different delays, etc., but the example embodiments are not limited thereto.

The RAN node 2000 may communicate with a core network (e.g., backend network, backhaul network, backbone network, Data Network, etc.) of the wireless communication network via a core network interface 2400. The core network interface 2400 may be a wired and/or wireless network interface and may enable the RAN node 2000 to communicate and/or transmit data to and from to network devices on the backend network, such as a core network gateway (not shown), a Data Network (e.g., Data Network 105), such as the Internet, intranets, wide area networks, telephone networks, VoIP networks, etc.

While FIG. 2 depicts an example embodiment of a RAN node 2000, the RAN node is not limited thereto, and may include additional and/or alternative architectures that may be suitable for the purposes demonstrated. For example, the functionality of the RAN node 2000 may be divided among a plurality of physical, logical, and/or virtual network elements, such as a centralized unit (CU), a distributed unit (DU), a remote radio head (RRH), and/or a remote radio unit (RRU), etc. Additionally, the RAN node 2000 may operate in standalone (SA) mode and/or non-standalone (NSA) mode using interfaces (not shown) such as X2, Xn, etc., between the RAN node 2000 and other RAN nodes of the wireless network, interfaces, such as S1, NG, etc., between the RAN node 2000 and the core network (e.g., core network 100), interfaces between network functions of the RAN node 2000 operating in a distributed and/or virtual RAN mode (not shown), such as F1, E1, etc., and/or interfaces between the physical layer (e.g., a baseband unit, etc.) and the radio layer (e.g., a RRH, core network interface 2400, etc.) (not shown), such as CPRI, eCPRI, etc., but the example embodiments are not limited thereto.

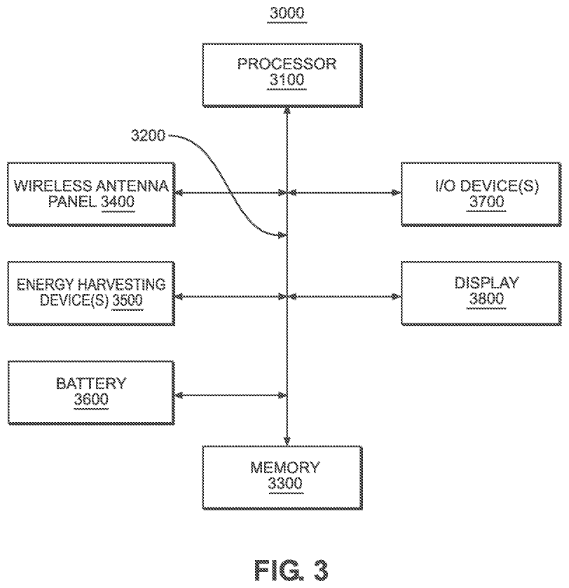

FIG. 3 illustrates a block diagram of an example UE device according to at least one example embodiment. The example UE device 3000 of FIG. 3 may correspond to one or more of the UE devices 120 and 130 of FIG. 1, but the example embodiments are not limited thereto, and the UE devices may employ alternative architectures, etc.

Referring to FIG. 3, a UE 3000 may include processing circuitry, such as at least one processor 3100, at least one communication bus 3200, a memory 3300, a plurality of wireless antennas and/or wireless antenna panels 3400, at least one input/output (I/O) device 3700 (e.g., a keyboard, a touchscreen, a mouse, a microphone, a camera, a speaker, etc.), and/or a display panel 3800 (e.g., a monitor, a touchscreen, etc.), but the example embodiments are not limited thereto. According to some example embodiments, the UE 3000 may include a greater or lesser number of constituent components, and for example, the UE 3000 may also include at least one energy harvesting device 3500, such as one or more solar cells/panels, wind turbines, water turbines, heat pumps, geothermal heat pumps, kinetic energy harvesting devices and/or vibration harvesting devices, radio frequency harvesting devices, etc., at least one battery 3600 (e.g., an energy storage device, etc.), etc., but the example embodiments are not limited thereto. Additionally, the UE 3000 may further include one or more proximity sensors (e.g., an infra-red proximity sensor, a capacitive proximity sensor, etc.), one or more location sensors (e.g., GPS, GLONASS, Beidou, Galileo, etc.), other sensors (e.g., thermometers, humidity sensors, pressure sensors, motion sensors, accelerometers, etc.), actuators, a single wireless antenna and/or a single wireless antenna panel, etc. Additionally, the display panel 3800, and/or I/O device 3700, etc., of UE 3000 may be optional.

In at least one example embodiment, the processing circuitry may include at least one processor (and/or processor cores, distributed processors, networked processors, etc.), such as the at least one processor 3100, which may be configured to control one or more elements of the UE 3000, and thereby cause the UE 3000 to perform various operations. The processing circuitry (e.g., the at least one processor 3100, etc.) is configured to execute processes by retrieving program code (e.g., computer readable instructions) and data from the memory 3300 to process them, thereby executing special purpose control and functions of the entire UE 3000. Once the special purpose program instructions are loaded into the processing circuitry (e.g., the at least one processor 3100, etc.), the at least one processor 3100 executes the special purpose program instructions, thereby transforming the at least one processor 3100 into a special purpose processor.

In at least one example embodiment, the memory 3300 may be a non-transitory computer-readable storage medium and may include a random access memory (RAM), a read only memory (ROM), and/or a permanent mass storage device such as a disk drive, or a solid state drive. Stored in the memory 3300 is program code (i.e., computer readable instructions) related to operating the UE 3000, such as the methods discussed in connection with FIGS. 5 to 7, etc. Such software elements may be loaded from a non-transitory computer-readable storage medium independent of the memory 3300, using a drive mechanism (not shown) connected to the UE 3000, or via the wireless antenna 3400, etc. Additionally, the memory 3300 may store network configuration information, such as system information, resource block scheduling, etc., for communicating with at least one RAN node, e.g., RAN node 110, etc., accessing a wireless network, etc., but the example embodiments are not limited thereto.

In at least one example embodiment, the at least one communication bus 3200 may enable communication and data transmission/reception to be performed between elements of the UE 3000, and/or monitor the status of the elements of the UE 3000 (e.g., monitor the current battery level of the battery 3600, monitor whether the energy harvesting device 3500 is currently active (e.g., harvesting and/or collecting energy) or currently inactive (e.g., not collecting energy), etc. The bus 3200 may be implemented using a high-speed serial bus, a parallel bus, and/or any other appropriate communication technology. According to at least one example embodiment, the UE 3000 may include a plurality of communication buses (not shown), such as an address bus, a data bus, etc.

The UE 3000 may also include at least one wireless antenna panel 3400, but is not limited thereto. The at least one wireless antenna panel 3400 may include at least one associated radio unit (not shown) and may be used to transmit wireless signals in accordance with at least one desired radio access technology, such as 4G LTE, 5G NR, Wi-Fi, etc. Additionally, the at least one wireless antenna panel 3400 may be configured to transmit and/or receive data communications, etc., but the example embodiments are not limited thereto. The at least one wireless antenna panel 3400 may be located at the same or different physical locations on the body of the UE 3000, may have the same or different orientations, may operate in the same or different frequency ranges, may operate in accordance with the same or different radio access technology, etc. According to some example embodiments, the at least one wireless antenna panel 3400 may be a single antenna, or may be a plurality of antennas, etc.

While FIG. 3 depicts an example embodiment of a UE 3000, the UE device is not limited thereto, and may include additional and/or alternative architectures that may be suitable for the purposes demonstrated.

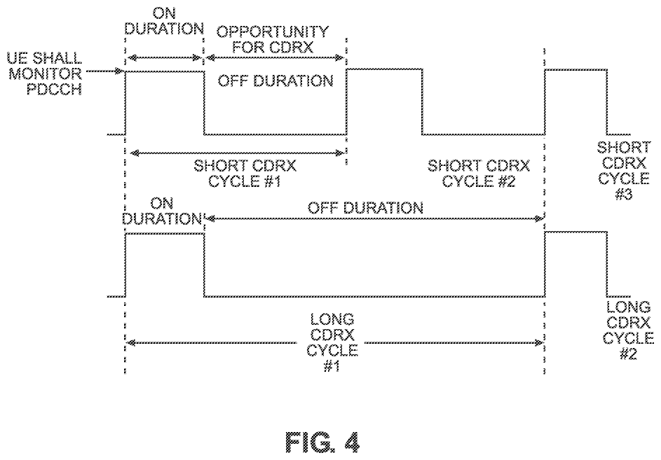

FIG. 4 illustrates an example connected mode CDRX cycle according to at least one example embodiment, but the example embodiments are not limited thereto.

As shown in FIG. 4, according to at least one example embodiment, a UE device, such as EH UE device 120, etc., may operate in a CDRX mode, but is not limited thereto. The EH UE device 120 (and the RAN node 110) may operate in either a short CDRX cycle mode or a long CDRX cycle mode, and the short CDRX cycle may last for one or more cycles, as shown in FIG. 4, but the example embodiments are not limited thereto. As shown in FIG. 4, the duration of a single long CDRX cycle may be the equivalent of multiple short CDRX cycles, but the example embodiments are not limited thereto. Additionally, each of the short CDRX cycles and/or the long CDRX cycles may include an ON duration of a desired and/or pre-defined length, during which the EH UE device 120 may monitor the PDCCH to determine whether there is data for reception on the core network 100 and/or RAN node 110, etc. Further, each of the short CDRX cycles and/or the long CDRX cycles may include an OFF duration of a desired and/or pre-defined length, during which the EH UE device 120 enters into a sleep mode and/or power saving mode, etc. According to at least one example embodiment, the OFF duration may be longer than the ON duration, but the example embodiments are not limited thereto.

Moreover, the core network 100 (e.g., network operator, etc.) and/or RAN node 110 may configure a short CDRX cycle timer (e.g., an initial short CDRX cycle timer and/or a default short CDRX cycle timer, etc.) which may be used to determine how many consecutive short CDRX cycles the EH UE device 120 operates in before switching to the long CDRX cycle, etc. In other words, the EH UE device 120 may be configured to perform a desired number of short CDRX cycles, defined by the short CDRX cycle timer, before returning to the long CDRX cycle, etc. However, according to some example embodiments, the EH UE device 120 may adaptively extend the amount of time operating in short CDRX cycle mode based on the current battery level of the EH UE device 120 and a desired EH CDRX energy threshold value, or in other words extend the number of consecutive short CDRX cycles, etc., and/or adaptively terminate a long CDRX cycle early, in order to increase and/or improve the latency, accessibility, and/or reliability of the EH UE device 120. Additionally, according to some example embodiments, if the current battery level of the EH UE device 120 falls below the desired EH CDRX threshold value, the EH UE device 120 may adaptively terminate the current short CDRX cycle which may improve sustainability of the EH UE device 120, such as potentially improving the battery life time of the EH UE device 120, ensuring that the EH UE device 120 does not prematurely run out of battery, etc. The adaptive EH CDRX modes will be discussed in greater detail in connection with FIGS. 5A to 5B.

FIG. 5A illustrates an example transmission flow diagram between at least one EH UE device and at least one RAN node according to at least one example embodiment. FIG. 5B illustrates an example flowchart of the EH-CDRX cycles according to at least one example embodiment.

Referring now to FIGS. 5A and 5B, according to at least one example embodiment, in operation S5010, a RAN node, such as RAN node 110 of FIG. 1, etc., may transmit a CDRX configuration message to at least one UE device, such as EH REDCAP UE device 120 of FIG. 1, etc., but the example embodiments are not limited thereto. The CDRX configuration may include initial and/or default CDRX configuration settings, such as an initial short CDRX cycle setting and/or an initial long CDRX cycle setting (e.g., non-EH related CDRX configuration settings, etc.). Additionally, the CDRX configuration may also include adaptive EH CDRX configuration settings, etc., but is not limited thereto. The adaptive EH CDRX configuration settings may include at least one of a desired EH CDRX energy threshold value (denoted as Er in FIGS. 5A to 5B), a short CDRX timer threshold value (denoted as K in FIGS. 5A to 5B), a short CDRX cycle extension threshold value (denoted as N in FIGS. 5A to 5B), an early short CDRX cycle termination threshold value (denoted as M in FIGS. 5A to 5B), and/or an early long CDRX cycle termination threshold value (denoted as delta in FIGS. 5A to 5B), etc., or any combinations thereof, but the example embodiments are not limited thereto. For example, according to at least one example embodiment, at least one of the short CDRX cycle extension threshold value, early short CDRX cycle termination threshold value, and/or the early long CDRX cycle termination threshold value may be omitted from the adaptive EH CDRX configuration settings and/or may be not implemented by the EH UE device 120 and/or RAN node 110, etc. Additionally, according to some example embodiments, the early short CDRX cycle termination threshold value M<short CDRX timer threshold value K, for reasons discussed below in connection with FIG. 5B.

As shown in FIG. 5B, it is assumed that the short CDRX cycle extension threshold value (N)=2, the early short CDRX cycle termination threshold value (M)=3, and the short CDRX timer threshold value (K)=6, for the sake of simplicity and clarity, but the example embodiments are not limited thereto, and any other values may be used for N, M, and K. Additionally, according to some example embodiments, the desired EH CDRX energy threshold value Er may be an individual value specific to a particular UE device on the network, and/or may be a percentage value, such that it is applicable to the battery capacity of the individual UE device and/or the amount of energy harvesting capable by the EH UE device, etc., but the example embodiments are not limited thereto.

In operation S5020 of FIG. 5A, and in corresponding operation S6010 of FIG. 5B, the EH UE device 120 may start a CDRX cycle, e.g., start a short CDRX cycle, based on the initial CDRX configuration settings. Additionally, the EH UE device 120 may initialize (e.g., set to zero) variables (and/or counters) corresponding to the various adaptive EH CDRX configuration settings included in the received CDRX configuration settings. For example, short CDRX timer variable “k”, a short CDRX cycle extension variable “n”, and/or an early short CDRX cycle termination variable “m”, etc., may be initialized to zero, but the example embodiments are not limited thereto. Moreover, the EH UE device 120 may determine a current energy level (E_{S}) of the battery of the EH UE device 120, etc. The current energy level E_{S} may be calculated as the sum of the currently stored energy level of the battery of the EH UE device 120 plus the energy being harvested from the EH device connected to and/or associated with the EH UE device 120, etc., but the example embodiments are not limited thereto.

In operation S6020, the EH UE device 120 determines whether the current energy level E_{S} is less than the desired EH CDRX energy threshold value E_{T}. Assuming that E_{S} is greater than or equal to E_{T}, in operation S5030, the EH UE device 120 transmits a message (e.g., an EH-CDRX message, a CDRX related message, etc.) to the RAN node 110 indicating that the EH UE device 120 has started a EH-CDRX cycle. According to some example embodiments, the EH UE device 120 may transmit the EH-CDRX message as an uplink control information (UCI) message over the physical uplink control channel (PUCCH), but the example embodiments are not limited thereto. Further, the indication that the EH UE device 120 has started the EH-CDRX cycle and/or is currently in an EH-CDRX cycle may be indicated as a 1-bit flag in the UCI message, but the example embodiments are not limited thereto.

In operation S6030, the EH UE device 120 may increment the short CDRX cycle extension variable, n, by 1 (e.g., n=n+1), and if applicable, may reset the early short CDRX cycle termination variable, m, to zero, etc., in response to the current energy level of the EH UE device 120 being greater than or equal to the desired energy threshold value, thereby indicating that the EH UE device 120 has sufficient energy stored to continue to operate in the short CDRX cycle mode.

In operation S6040, the EH UE device 120 may determine whether the short CDRX cycle extension variable n is equal to the short CDRX cycle extension threshold value N (e.g., n=N). The short CDRX cycle extension threshold value N is a threshold which provides and/or sets a desired and/or maximum number of times that the EH-short CDRX cycles may be performed (e.g., the desired and/or maximum number of times that the short CDRX cycle may be extended, etc.) consecutively before incrementing a short CDRX timer variable k value. According to some example embodiments, the short CDRX timer variable k value and a short CDRX timer threshold value K may be used to determine whether the EH UE device starts a long CDRX cycle, thereby ensuring that the EH UE device 120 does not operate in short CDRX cycle mode indefinitely if there is no data on the network for the EH UE device 120, and therefore does not continually and/or unnecessarily expend energy, even if the current energy levels and/or amount of energy being harvested are sufficient. Additionally, in corresponding operation S5050, the EH UE device 120 may transmit an EH-CDRX message (e.g., a UCI message, an CDRX related message, etc.) to the RAN node 110 indicating that the EH UE 120 is stopping the EH-CDRX cycle in response to the short CDRX cycle extension variable n equaling the short CDRX cycle extension threshold value N (e.g., n=N), but the example embodiments are not limited thereto. For example, according to some example embodiments, the EH UE device 120 may transmit the EH-CDRX message regarding the stoppage of the EH-CDRX cycle at other times, such as in operations S6060, S6070, etc.

Referring now to operation S6050, in the event that the short CDRX cycle extension variable n is not equal to the short CDRX cycle extension threshold value N, the EH UE device 120 starts the next short CDRX cycle. Further, in optional operation S5040 corresponding to operation S6050, the EH UE device 120 may transmit another EH-CDRX message to the RAN node 110 indicating that the EH-cycle is still ongoing (e.g., transmit another UCI message (and/or CDRX related message) with the 1-bit EH-CDRX cycle flag set), etc., but the example embodiments are not limited thereto.

In the event that the short CDRX cycle extension variable n is equal to the short CDRX cycle extension threshold value N, in operation S6060, the UE device 120 may increment the short CDRX timer variable k value (e.g., k=k+1) and may reset the short CDRX cycle extension variable n value to zero (e.g., n=0), etc. Next, in operation S6070, the EH UE device 120 may determine whether the short CDRX timer variable k value equals the short CDRX timer threshold value K (e.g., k=K), and/or the EH UE device 120 may determine whether the early short CDRX cycle termination variable m equals the early short CDRX cycle termination threshold value M (e.g., m=M), but the example embodiments are not limited thereto. Further, while FIG. 5B illustrates the UE device 120 concurrently evaluating both the short CDRX timer variable k and the early short CDRX cycle termination variable m in operation S6070, the example embodiments are not limited thereto, and for example, the short CDRX timer variable k evaluation or the early short CDRX cycle termination variable evaluation may be omitted.

In operation S6090, in response to either the short CDRX timer variable k or the early short CDRX cycle termination variable m being equal to the short CDRX timer threshold value K or the early short CDRX cycle termination threshold value M, respectively, the EH UE device 120 may start the long CDRX cycle. In other words, if the EH UE device 120 determines that the UE device has performed the EH-short CDRX cycle the maximum number of times, the EH UE device 120 will start the long CDRX cycle, etc. Additionally, in corresponding operation S5060, the EH UE 120 may transmit an EH-CDRX message (e.g., UCI message, CDRX related message, etc.) to the RAN node 110 indicating that the EH UE 120 is stopping the short CDRX cycle timer in response to the early short CDRX cycle termination variable m equaling the early short CDRX cycle termination threshold value M (e.g., m=M), and/or the EH UE 120 may transmit an EH-CDRX message (e.g., a UCI message, a CDRX related message, etc.) to the RAN node 110 indicating that the EH UE 120 is starting the long CDRX cycle, thereby causing the RAN node 110 to begin performing communication with the EH UE 120 based on the CDRX settings and/or parameters of the long CDRX cycle, but the example embodiments are not limited thereto.

Referring back to operation S6070, in the event that neither the short CDRX timer variable k nor the early short CDRX cycle termination variable m are equal to the short CDRX timer threshold value K or the early short CDRX cycle termination threshold value M, respectively, in operation S6050, the EH UE device 120 may start the next iteration of the short CDRX cycle.

Now, returning to operation S6020, in the event that the EH UE device 120 determines that the current energy level E_{S} is less than the desired energy threshold value E_{T}, in operation S6080, the EH UE device 120 may increment the short CDRX timer variable k (k=k+1), and may increment the early short CDRX cycle termination variable m. Additionally, the EH UE device 120 may reset the short CDRX cycle extension variable n value to zero (n=0), but the example embodiments are not limited thereto. Next, in operation S6070, the EH UE device 120 again determines whether the short CDRX timer variable k or the early short CDRX cycle termination variable m are equal to the short CDRX timer threshold value K or the early short CDRX cycle termination threshold value M, respectively. In the situation where the EH UE device 120 is not harvesting enough energy to maintain the current energy level E_{S} above the desired energy threshold value E_{T}, the EH UE device 120 may terminate the short CDRX cycle early and enter the long CDRX cycle (e.g., operation S6090) based on the early short CDRX cycle termination variable m, thereby improving the energy efficiency of the EH UE device and avoid unnecessarily wasting the energy stored in the battery of the EH UE device 120, etc. Additionally, in corresponding operation S5060, when the early short CDRX cycle termination variable m is equal to the early short CDRX cycle termination threshold value M, the EH UE device 120 may transmit an EH-CDRX message (e.g., a UCI message, a CDRX related message, etc.) to the RAN node 110 indicating that the short CDRX cycle timer is stopped and/or that the EH UE device 120 has entered long CDRX cycle, etc.

Now, moving onto operation S6100, while the EH UE device 120 is in the long CDRX cycle mode, the EH UE device 120 may measure the current energy level E_{S} of the battery of the EH UE device 120, and determine whether the current energy level E_{S} is greater than or equal to the sum of the desired EH CDRX energy threshold value and the early long CDRX cycle termination threshold value (denoted as “delta” in FIGS. 5A to 5B). The early long CDRX cycle termination threshold value may be considered an offset value to the desired EH CDRX energy threshold value and is set so that the EH UE device 120 does not “ping-pong,” or repeatedly change, between the EH-short CDRX cycle and the long CDRX cycle, when the current energy level E_{S} is hovering around the desired EH CDRX energy threshold value E_{T}. In the event that the current energy level E_{S} is greater than or equal to the sum of the desired EH CDRX energy threshold value and the early long CDRX cycle termination threshold value delta, in operation S6120, the EH UE device 120 may terminate the long CDRX cycle early (e.g., immediately exit the long CDRX cycle, etc.) and enter the EH-short CDRX cycle (e.g., return to operation S6010), etc. Additionally, in corresponding operation S5070, the EH UE device 120 may transmit an EH-CDRX message (e.g., a UCI message, a CDRX related message, etc.) to the RAN node 110 indicating to the RAN node 110 to stop the long CDRX cycle and resume the short CDRX cycle (e.g., the EH-short CDRX cycle), etc., but the example embodiments are not limited thereto.

Referring back to operation S6100, in the event that the current energy level E_{S} is less than the sum of the desired EH CDRX energy threshold value and the early long CDRX cycle termination threshold value delta, the EH UE device 120 continues (e.g., maintains, etc.) the long CDRX cycle in operation S6110.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A user equipment (UE) device comprising:
a memory storing computer readable instructions; and
processing circuitry configured to execute the computer readable instructions to cause the device to, obtain connected mode discontinuous reception (CDRX) configuration from a Radio Access Network (RAN) node, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value,
determine whether a current stored energy capacity equals or exceeds the desired EH CDRX energy threshold value at a start of an ON duration of a CDRX cycle,
determine EH CDRX settings based on results of the determining whether the current stored energy capacity equals or exceeds the desired EH CDRX energy threshold value and the plurality of adaptive EH CDRX configuration settings, and
transmit at least one EH CDRX message to the RAN node based on the determined EH CDRX settings.

2. The device of claim 1, wherein
the plurality of adaptive EH CDRX configuration settings further includes a short CDRX cycle extension threshold value; and
the device is further caused to,
initialize a value of a short CDRX cycle extension variable; and
in response to the current stored energy capacity equaling or exceeding the desired EH CDRX energy threshold value,
increment the value of the short CDRX cycle extension variable,
determine whether the value of a short CDRX cycle extension variable equals the short CDRX cycle extension threshold value, and
transmit a first EH CDRX message to the RAN node, the first EH CDRX message indicating a start of a EH short CDRX cycle.

3. The device of claim 2, wherein the device is further caused to determine the EH CDRX settings by, in response to the value of the short CDRX cycle extension variable equaling the short CDRX cycle extension threshold value, or in response to the current stored energy capacity being less than the desired EH CDRX energy threshold value:
resetting the value of the short CDRX cycle extension variable;
incrementing a value of a short CDRX timer variable;
determining whether the incremented value of the short CDRX timer variable equals the short CDRX timer threshold value; and
starting a long CDRX cycle based on the results of the determining whether the incremented value of the short CDRX timer variable equals the short CDRX timer threshold value.

4. The device of claim 1, wherein
the plurality of adaptive EH CDRX configuration settings further includes an early short CDRX cycle termination threshold value; and
the device is further caused to determine the EH CDRX settings by, in response to the current stored energy capacity equaling or exceeding the desired EH CDRX energy threshold value,
resetting an early short CDRX cycle termination variable.

5. The device of claim 4, wherein the device is further caused to determine the EH CDRX settings by, in response to the current stored energy capacity being less than the desired EH CDRX energy threshold value:
incrementing the value of the early short CDRX cycle termination variable;
determining whether the incremented value of the early short CDRX cycle termination variable equals the early short CDRX cycle termination threshold value; and
transmitting a second EH CDRX message to the RAN node based on results of the determining whether the incremented value of the early short CDRX cycle termination variable equals the early short CDRX cycle termination threshold value, the second EH CDRX message indicating a stop to the short CDRX cycle timer.

6. The device of claim 4, wherein a value of the early short CDRX cycle termination threshold value is less than the value of the short CDRX timer threshold value.

7. The device of claim 1, wherein
the plurality of adaptive EH CDRX configuration settings further includes an early long CDRX cycle termination threshold value; and
the device is further caused to,
determine the EH CDRX settings by determining whether the current stored energy capacity equals or exceeds the desired EH CDRX energy threshold value and the early long CDRX cycle termination threshold value at a start of an ON duration of a long CDRX cycle, and
transmit a third EH CDRX message to the RAN node, the third EH CDRX message indicating an end of the long CDRX cycle.

8. The device of claim 1, wherein the device is further caused to:
transmit at least one of the first EH CDRX message, a second EH CDRX message, a third EH CDRX message, or any combinations thereof, as an Uplink Control Information (UCI) message, the UCI message including a 1-bit flag indicating the determined EH CDRX settings.

9. The device of claim 1, wherein the device further comprises:
at least one energy harvesting device; and
at least one battery configured to store energy obtained by the at least one energy harvesting device.

10. A method of operating a user equipment (UE) device, the method comprising:
obtaining connected mode discontinuous reception (CDRX) configuration from a Radio Access Network (RAN) node, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value;
determining whether a current stored energy capacity equals or exceeds the desired EH CDRX energy threshold value at a start of an ON duration of a CDRX cycle;
determining EH CDRX settings based on results of the determining whether the current stored energy capacity equals or exceeds the desired EH CDRX energy threshold value and the plurality of adaptive CDRX configuration settings; and
transmitting at least one EH CDRX message to the RAN node based on the determined EH CDRX settings.

11. The method of claim 10, wherein
the plurality of adaptive EH CDRX configuration settings further includes a short CDRX cycle extension threshold value;
the determining the EH CDRX settings further includes,
initializing a value of a short CDRX cycle extension variable, and
in response to the current stored energy capacity equaling or exceeding the desired EH CDRX energy threshold value, the method further includes,
incrementing the value of the short DRX cycle extension variable,
determining whether a value of a short CDRX cycle extension variable equals the short CDRX cycle extension threshold value, and
transmitting a first EH CDRX message, the first EH CDRX message indicating a start of an EH short CDRX cycle.

12. The method of claim 11, wherein the determining the EH CDRX settings further comprises, in response to the value of the short CDRX cycle extension variable equaling the short CDRX cycle extension threshold value, or in response to the current stored energy capacity being less than the desired EH CDRX energy threshold value:
resetting the value of the short CDRX cycle extension variable;
incrementing a value of a short CDRX timer variable;
determining whether the incremented value of the short CDRX timer variable equals the short CDRX timer threshold value; and starting a long CDRX cycle based on the results of the determining whether the incremented value of the short CDRX timer variable equals the short CDRX timer threshold value.

13. The method of claim 10, wherein
the plurality of adaptive EH CDRX configuration settings further includes an early short CDRX cycle termination threshold value; and
the determining the EH CDRX settings further comprises, in response to the current stored energy capacity equaling or exceeding the desired EH CDRX energy threshold value,
resetting an early short CDRX cycle termination variable.

14. The method of claim 13, wherein the determining the EH CDRX settings further comprises, in response to the current stored energy capacity being less than the desired EH CDRX energy threshold value:
incrementing the value of the early short CDRX cycle termination variable;
determining whether the incremented value of the early short CDRX cycle termination variable equals the early short CDRX cycle termination threshold value; and
transmitting a second EH CDRX message to the RAN node based on results of the determining whether the incremented value of the short CDRX cycle termination variable equals the early short CDRX cycle termination threshold value, the second EH CDRX message indicating a stop to the short CDRX cycle timer.

15. The method of claim 13, wherein a value of the early short CDRX cycle termination threshold value is less than the value of the short CDRX timer threshold value.

16. The method of claim 10, wherein
the plurality of adaptive EH CDRX configuration settings further includes an early long CDRX cycle termination threshold value;
the determining the EH CDRX settings further comprises,
determining whether the current stored energy capacity equals or exceeds the desired EH CDRX energy threshold value and the early long CDRX cycle termination threshold value at a start of an ON duration of a long CDRX cycle; and
the method further comprises,
transmitting a third EH CDRX message to the RAN node, the third EH CDRX message indicating an end of the long CDRX cycle.

17. The method of claim 10, wherein the method further comprises:
transmitting at least one of the first EH CDRX message, a second EH CDRX message, a third EH CDRX message, or any combinations thereof, as an Uplink Control Information (UCI) message, the UCI message including a 1-bit flag indicating the determined EH CDRX settings.

18. The method of claim 10, wherein the method further comprises:
storing energy obtained from at least one energy harvesting device into at least one battery of the UE device.

19. A radio access network (RAN) node comprising:
a memory storing computer readable instructions; and
processing circuitry configured to execute the computer readable instructions to cause the node to,
transmit connected mode discontinuous reception (CDRX) configuration to at least one energy harvesting (EH) user equipment (UE) device, the CDRX configuration including a plurality of adaptive energy harvesting (EH) CDRX configuration settings, the plurality of adaptive EH CDRX configuration settings including at least a desired EH CDRX energy threshold value, and a short CDRX timer threshold value; and
receive at least one EH CDRX message from the at least one EH UE device, the at least one EH CDRX message indicating EH CDRX settings determined based on at least a current stored energy capacity of the at least one EH UE device, the desired CDRX energy threshold value and the plurality of adaptive CDRX configuration settings.

20. The node of claim 19, wherein the node is further caused to:
transmit the CDRX configuration to a plurality of EH UE devices connected to the node.
